(19) United States
(12) Patent Application Publication
(10) Pub. No.: US 2026/0003322 A1
(43) Pub. Date: Jan. 1, 2026

(54) Hologram Interlacing with Diagonal Offset

(71) Applicant: Envisics Ltd, Milton Keynes (GB)

(72) Inventors: Ruisheng Lin, Milton Keynes (GB); Timothy Smeeton, Milton Keynes (GB)

(21) Appl. No.: 19/206,593

(22) Filed: May 13, 2025

(30) Foreign Application Priority Data
May 30, 2024 (GB) 2407683.8

(51) Int. Cl. G03H 1/22

(52) U.S. Cl. CPC G03H 1/2205; G03H 2001/2231; G03H 2223/23

(57) ABSTRACT

A holographic projection system arranged to display a target picture and a method of holographic projection is disclosed. A hologram comprises a first sub-hologram corresponding to a first picture area of a picture and a second sub-hologram corresponding to the second picture area of the picture. The first and second picture areas are spatially displaced in at least one of first and second orthogonal dimensions. A portion of a holographic wavefront corresponding to the first-sub-hologram is steered in a first diagonal direction with respect to a propagation axis. A portion of a holographic wavefront corresponding to the first-sub-hologram is steered in a second diagonal direction with respect to a propagation axis. The second diagonal direction is different from the first diagonal direction in at least one of the first and second dimensions.

### CROSS-REFERENCE TO RELATED APPLICATIONS

This application claims priority under 35 U.S.C. § 119 to UK Patent Application GB 2407683.8 titled “Hologram Interlacing With Diagonal Offset,” filed on May 30, 2024, and currently pending. The entire contents of GB 2407683.8 are incorporated by reference herein for all purposes.

### FIELD

The present disclosure relates to a holographic projection system arranged to display a target picture and a method of holographic projection of a target picture. More particularly, the present disclosure relates to a holographic projection system arranged to display a target picture comprising multiple picture areas with improved picture quality. Some embodiments relate to a holographic projector, picture generating unit or head-up display.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

A first aspect of the present disclosure is a holographic projection system arranged to display a picture. The system comprises a hologram of a picture and a holographic wavefront redirector. The hologram may be displayed on a first spatial light modulator. The wavefront redirector may be a bulk optic—e.g. transparent material with plurality of inclined surfaces arranged to provide refraction—or a phase-delay pattern or distribution or surface display on a second spatial light modulator. The first spatial light modulator and second spatial light modulator may have the same pixel pitch or a different pixel pitch. Areas of the holographic wavefront redirector correspond to areas of the hologram.

The hologram comprises a first sub-hologram of a first picture area of the picture and a second sub-hologram corresponding to a second picture area of the picture. Alternatively, it may simply be said that the hologram comprises a first hologram of a first picture and a second hologram of a second picture. The prefix “sub” and the term picture “area” are merely used herein to reflect that, in some embodiments, the first picture area and second picture area are two halves of a field of view (or big picture) that are perfectly stitched together by the holographic wavefront redirector.

The holographic wavefront redirector is disposed substantially adjacent to the hologram, or a relayed copy of the hologram. In some embodiments, an optical replay is used to form an image of the hologram downstream of the display device. The holographic wavefront redirector may be arranged in cooperation with the (original) hologram or the image thereof. In some embodiments, the hologram is displayed on a spatial light modulator.

The holographic wavefront redirector comprises one or more first redirection zones optically coupled to the first sub-hologram. The holographic wavefront redirector further comprises one or more second redirection zones optically coupled to the second sub-hologram. Each of the first redirection zones is arranged to steer or turn received light (from the first sub-hologram) by a first diagonal turn with respect to a propagation axis of the system. Each of the second redirection zones is arranged to steer or turn received light (from the second sub-hologram) by a second diagonal turn with respect to the propagation axis. The second diagonal turn is different to the first diagonal turn. In some embodiments, the second diagonal turn is substantially equal and opposite to the first diagonal direction in at least the first dimension.

The person skilled in the art of optics will appreciate how etendue can be a limiting factor in the design of display systems. The present disclosure avoids the overlap between a primary (desired) image and both the so-called holographic DC spot and higher diffraction orders—making angular expansion possible. In some respects, it may be said that the present disclosure provides etendue expansion.

The term “optically coupled” is used herein to mean that the redirection zones are each arranged (e.g. positioned or disposed) to receive light modulated in accordance with a respective part of the hologram—but not receive light from any other redirection zone.

The first diagonal turn and second diagonal turn may each comprise a first (e.g. horizontal) angular component and second (e.g. vertical) angular component with respect to the propagation axis (e.g. the normal to the hologram).

A notable feature of the present disclosure is that diagonal optical “turns” are provided. This has the two-fold effect of 1/translating the primary image away from the holographic DC spot and 2/shifting the two sets of higher orders onto opposing diagonals such that overlap between the first primary image and a higher order repeat of a second primary image is reducible or even avoidable.

The first angular component and second angular component are perpendicular to each other—and, optionally, perpendicular to the propagation axis too. The first angular component may correspond to a first dimension of the hologram. The second angular component may correspond to a second dimension of the hologram. For example, the first angular component and first dimension of the hologram may be in the horizontal direction and the second angular component and second dimension of the hologram may in the vertical direction.

The first angular component of the first diagonal turn may be equal and opposite to the first angular component of the second diagonal turn.

The first angular component of the first diagonal turn and second diagonal turn may both be equal, in magnitude, to half the diffraction angle of the hologram in the corresponding direction so that the first and second picture areas are side-by-side in a first (e.g. horizontal dimension. The term “diffraction angle of the hologram” is used herein to reflect that the hologram may be displayed on a display device comprising pixels with a pixel pitch that defines a diffraction angle. The diffraction angle in a first dimension (e.g. horizontal or x-direction) of the display device (or hologram) may be the same or different to the diffraction angle in the second dimension (e.g. vertical or y-direction) of the display device (or hologram).

The second angular component of the first diagonal turn may be equal to the second angular component of the second diagonal turn. The second angular component of the first diagonal turn and the second angular component of the second diagonal turn may both be at least equal to the diffraction angle of the hologram in the corresponding direction.

In some embodiments, the holographic wavefront redirector is a bulk optic comprising a transparent material and two opposing, major surfaces. For example, the transparent material may be a glass or transparent polymer. A first major surface may be an input surface that is coupled to the hologram. The first surface may be substantially planar.

That is, each redirection zone may be formed from a transparent material comprising a first (e.g. input) surface arranged to receive light modulated in accordance with a respective part of the hologram, and a second (e.g. output) surface arranged to refract the light modulated in accordance with the respective part of the hologram in order to provide the corresponding diagonal turn. The first and second surfaces may be opposing. The transparent material may be substantially planar. The first surface may adjoin or abut the hologram, or display device of some embodiments. Embodiments using a bulk optic may be advantageous for reducing diffractive effects such as those caused by using a pixeled display device or Fresnel-like structure.

The second, opposing major surface may be shaped. For example, the second surface may comprise a prismatic array or may be serrated. In some embodiments, a plurality of first redirection zones are inclined in a first direction and a plurality of second redirection zones are inclined in a second direction opposite or complementary to the first direction. The first and second zones may be interleaved. The inclines surfaces may provide refraction corresponding to the optical or wavefront “turn” described herein.

The first (e.g. input) surface of each of the first redirection zones is substantially parallel to a plane of the hologram (or corresponding holographic wavefront—when the hologram is illuminated) and the second (e.g. output) surface of each of the first redirection zones is tilted by a first tilt angle with respect to the plane of the hologram (or holographic wavefront) such that an angle of incidence of received light on the second surface is greater than zero.

Likewise, the first surface of each of the second redirection zones may be substantially parallel to the plane of the hologram (or holographic wavefront) and the second (e.g. output) surface of each of the second redirection zones is tilted by a second tilt angle with respect to the plane of the hologram (or holographic wavefront) such that an angle of incidence of received light on the second surface is greater than zero. The first tilt angle may be equal (in magnitude) and opposite (in direction) to the second tilt angle.

Optionally, an angle of incidence on the first surface is substantially zero.

The first tilt angle and second tilt angle both have a component in two perpendicular directions, wherein the two perpendicular directions are both also perpendicular to the propagation axis.

The word “tilt” is used herein with respect to a surface to refer to an angle between the surface normal of said surface and the propagation axis of light (or holographic wavefront) received by said surface.

Each second surface may be divided into a Fresnel-type structure comprising a plurality of repeating, second surface components. This approach may reduce the thickness of the component. The person skilled in the art will be familiar with a Fresnel lens and the concept of phase “wrapping” based around the principle that phase is repeating/periodic such that e.g. a 3π phase delay is the same as a π phase delay.

In some embodiments, the holographic wavefront redirector is a phase-delay function (or distribution) displayed on a spatial light modulator (e.g. arranged to mimic the bulk optic structure described above). The spatial light modulator may be a liquid crystal on silicon, “LCOS”, device. These embodiments are advantageous because they provide dynamic reconfigurability.

In these embodiments, each redirection zone may be described as comprising a phase-ramp function—or a plurality of phase-ramp functions—each arranged to provide a corresponding turn. Each phase-ramp function may be linear and/or two-dimensional. Each linear, two-dimensional phase-ramp displayed on a spatial light modulator is optically equivalent to a tilted surface.

In some embodiments, the holographic wavefront redirector is a hybrid/combination of a bulk optic (hardware implementation) and display device (software implementation). That is, some steering or turn is provided in hardware and some is provided in software.

Hardware implementation requires only a 2D diffraction element which is simple and inexpensive. It is suitable for a specific application where the replay field is redistributed to a known position or layout. Software implementation is flexible but expensive. Pure software implementation requires an additional spatial light modulator with very high bandwidth (accurate phase value, small pixel size, etc.). This can be mitigated by combining a hardware and software implementation, i.e. use hardware diffraction for coarse image steering and software for fine tuning. A software implementation provides the degree of freedom to choose what to display in each replay (i.e. Zone 1,2,3,4) and where—and more importantly, these are changeable.

In some comparative examples in which the holographic wavefront redirector is a (light modulation) function (or pattern) for display on pixels of a display device, the function can be added to the hologram of the picture. In some examples, the light modulation function is referred to as a “grating”—as described above. Therefore, in examples, a grating is added on top of the hologram on a common display device to shift image portions. However, in these examples, the limitation is that the amount of steering is limited by the pixel size of the modulator so using the same modulator for both the hologram and steering results in insufficient separation of the different replays areas.

The holographic wavefront redirector may comprise a diffractive structure. In accordance with this disclosure, a “diffractive structure” is a structure having a periodicity that causes diffraction of the received holographic wavefront from the hologram. The person skilled in the art of optics will appreciate that factors such as the magnitude of the periodicity and the wavelength of the light determine whether (observable) diffraction occurs. The diffraction structure may correspond to: the periodicity of the first and/or second redirection zones; the periodicity of the Fresnel-type structure/s; and/or the periodicity of the pixels of the spatial light modulator used to display or represent the (phase pattern of the) holographic wavefront redirector.

Other expressions of the present disclosure are summarised in the following paragraphs.

There is disclosed herein a holographic projection system arranged to display a picture. The projection system comprises a hologram of a picture. The hologram comprises a first sub-hologram corresponding to a first picture area of the picture. The first picture area may comprise first picture content. The hologram further comprises a second sub-hologram corresponding to a second picture area of the picture. The second picture area may comprise second picture content. The projection system further comprises a holographic wavefront redirector positioned substantially adjacent to the hologram or a relayed hologram. The holographic wavefront redirector comprises one or more first redirection zones optically coupled to the first sub-hologram. The holographic wavefront redirector further comprises and one or more second redirection zones optically coupled to the second sub-hologram. Each of the first redirection zones is arranged to steer received light (e.g., a portion of a holographic wavefront formed by the hologram or relayed hologram corresponding to the first sub-hologram) in a first diagonal direction with respect to a propagation axis of the system. Each of the second redirection zones is arranged to steer received light (e.g., a portion of a holographic wavefront formed by the hologram or relayed hologram corresponding to the second sub-hologram) in a second diagonal direction with respect to the propagation axis.

Each of the first and second diagonal directions may define a first angle in the first dimension with respect to the propagation axis and a second angle in the second dimension, perpendicular to the first dimension, with respect to the propagation axis. As the skilled person will appreciate, the displacement of the displayed first and second picture areas, and thus the degree of separation/overlap, in the first dimension is dependent upon the first angles of the first and second diagonal directions with respect to the propagation axis.

In some examples, the holographic wavefront redirector is arranged to steer light of the first and second sub-holograms so that the first picture area is displayed adjacent to (e.g., contiguous with or slightly separated/partially overlapping) the second picture area in a first dimension. Thus, the second diagonal direction is substantially equal and opposite to the first diagonal direction in the first dimension.

The first and second picture areas may be arranged side-by-side in a first dimension. For example, the picture may be divided into first and second picture areas that are arranged side-by-side in the first dimension. Accordingly, the second diagonal direction may be equal and opposite to the first diagonal direction in at least the first dimension. Thus, the first angle of the first diagonal direction is equal and opposite to the first angle of the second diagonal direction.

The holographic wavefront redirector is arranged to form a holographic reconstruction comprising first picture content in the first picture area and second picture content in the second picture area. The primary diffraction orders of the first and second picture areas of the holographic reconstruction form the field of view seen by a viewer at a viewing window. The at least one first redirection zone steers light by the substantially the same amount (e.g., by the same (first) angle) in the first dimension as the at least one second redirection zone, but in opposite directions. In this case, the primary diffraction orders of the first and second picture areas of the holographic reconstruction are arranged side-by-side (e.g., contiguous or slightly overlapping/separated) in the first dimension. Since the at least one first redirection zone steer lights in a first diagonal direction, and thus by an amount (e.g., second angle) in the second dimension perpendicular to the first dimension, the primary and higher diffraction orders of the first picture area of the holographic reconstruction are spatially separated along a first diagonal line. Similarly, since the at least one second redirection zones is light in a second diagonal direction, the primary and higher diffraction orders of the second picture area of the holographic reconstruction are spatially separated along a second diagonal line. The second diagonal line extends in an opposite direction to the first diagonal line in the first dimension. Thus, the higher diffraction orders of the first and second picture areas of the holographic reconstruction are formed outside the area of the primary diffraction orders, and therefore outside the area of the field of view seen by the viewer. In addition, the zero order is similarly spatially separated from the field of view.

Accordingly, first and second portions of a holographic wavefront corresponding to respective first and second picture areas of a target picture are redirected in respective first and second diagonal directions. This makes it possible to position the picture areas of the primary diffraction order as required (e.g., arranged side-by-side) to form the desired field of view. At the same time, the picture areas of the higher diffraction orders are automatically spatially separated diagonally from the primary diffraction orders, and therefore outside the field of view, so that there is no overlap of picture content from the higher diffraction orders with the primary diffraction order. In addition, the zero order picture content is also spatially separated from the primary diffraction order forming the field of view. Accordingly, no duplicate or ghost pictures formed by the zero or higher direction orders, as described above with reference to FIGS. 7A and 7B, are seen by the viewer in the field of view.

In some arrangements, the holographic wavefront redirector is arranged so that a magnitude of the first angle of each of the first and second diagonal directions in the first dimension is substantially equal to half the diffraction angle of the display device.

In some arrangements, the holographic wavefront redirector is arranged so that a magnitude of the second angle of each of the first and second diagonal directions in the second dimension is substantially equal to, or greater than, one diffraction angle of the display device.

In other examples, the holographic wavefront redirector is arranged to steer light of the first and second sub-holograms so that the first picture area/content is displayed spatially separated from the second picture area/content. For example, the first and second picture areas/content may be spatially separated in at least one of the first and second dimensions. In these examples, the second diagonal direction is different from the first diagonal direction in at least one of the first and second dimensions. As the skilled person will appreciate, the spatial displacement of the displayed first and second picture areas in the first and second dimension is dependent upon the first and second angles, defined by the first and second diagonal directions, with respect to the propagation axis. The first and second angles may be chosen so that the primary diffraction orders of the first and second picture areas of a holographic reconstruction (formed from the holographic wavefront) are positioned to form the first and second picture areas with the desired spatial displacement within the field of view, whilst preventing the zero order and higher diffraction orders of the first and second picture areas of the holographic reconstruction from overlapping the field of view.

In embodiments, the holographic projection system further comprises a display device arranged to display the hologram. The display device may comprise a plurality of pixels. The display device may comprise spatial light modulator, such as a phase modulator. For example, the spatial light modulator may comprise a liquid crystal on silicon (LCOS) display device.

In some arrangements, the holographic wavefront redirector comprises a diffraction element. In examples, the least one first redirection zone comprises an array of first optical elements (forming grating lines/slits) having a first grating pitch. The at least one second redirection zone comprises an array of second optical elements (forming grating lines/slits) having a second grating pitch. The second grating pitch may be the same as, or different from, the first grating pitch.

In some examples, each optical element (grating line or slit) of the diffraction element comprises an input surface and an output surface. The input surface is arranged to receive a portion of a holographic wavefront formed by illuminating the hologram, and the output surface arranged to output the respective portion of the holographic wavefront. The input surface of each of the first optical elements may be tilted by a first tilt angle with respect to a plane in the first and second dimensions. Thus, an angle of incidence of received light on the input surface of each of the first optical element is greater than zero. The input surface of each of the second optical elements may be tilted by a second tilt angle with respect to a plane in the first and second dimensions. Thus, an angle of incidence of received light on the input surface of each of the second optical elements is greater than zero. The first tilt angle may be substantially equal and opposite to the second tilt angle. Additionally, or alternatively, the output surface of each of the first optical elements may be tilted by a third tilt angle with respect to a plane in the first and second dimensions. Similarly, the output surface of each of the second optical elements may be tilted by a fourth tilt angle with respect to a plane in the first and second dimensions. The third tilt angle may be substantially equal and opposite to the fourth tilt angle.

In some arrangements, the holographic projection system comprises an optical relay comprising a pair of lenses arranged to receive the holographic wavefront. In particular, the pair of lenses are arranged in cooperation to form a relayed hologram at a first plane. The first plane may extend in the first and second dimensions. The relayed hologram is an image of the hologram.

There is disclosed herein a method for holographic projection of a picture. The picture may comprise first and second picture areas, which may be arranged side-by-side in a first dimension. The method comprises displaying a hologram of the picture. The hologram comprises a first sub-hologram corresponding to the first picture area and a second sub-hologram corresponding to a second picture area. The method further comprises illuminating the hologram with light to form a holographic wavefront. The holographic wavefront may extend in the first dimension and a second dimension perpendicular to the first dimension. Light of the holographic wavefront may propagate in a third dimension perpendicular to the first and second dimensions. It may be said that a propagation axis of a light field forming the holographic wavefront extends in the third dimension. A first portion of the holographic wavefront is formed by the first sub-hologram and a second portion of the holographic wavefront is formed by the second sub-hologram. The method further comprises steering light of the first portion of the holographic wavefront in a first diagonal direction with respect to a propagation axis (which extends in the third dimension). The method further comprises steering light of the second portion of the holographic wavefront in a second diagonal direction with respect to the propagation axis (which extends in the third dimension). The second diagonal direction is different from the first diagonal direction. For example, the second diagonal direction may be substantially equal (in magnitude) and opposite (in direction) to the first diagonal direction in at least the first dimension.

In some embodiments, the method comprises receiving the steered light of the first and second portions of the holographic wavefront and forming a holographic reconstruction corresponding to the picture at a display plane (e.g., replay plane). The field of view of holographic reconstruction comprises a primary diffraction order. The primary diffraction order of the holographic reconstruction of the first sub-hologram (corresponding to the first picture area) is spatially separated from the holographic reconstruction of the second sub-hologram (corresponding to the second picture area) in the field of view. The zero order and/or the higher diffraction orders of the holographic reconstruction of the first and second sub-holograms are spatially separated from the primary diffraction orders.

In some embodiments, the method comprises displaying the hologram on a display device. Each of the first and second diagonal directions defines a first angle in the first dimension with respect to the propagation axis and a second angle in the second dimension with respect to the propagation axis. A magnitude of the second angle of each of the first and second diagonal directions in the second dimension is substantially equal to, or greater than, one diffraction angle of a display device. Accordingly, the zero order and the higher diffraction orders of the first and second sub-holograms do not overlap the primary diffraction orders of the first and second sub-holograms in the field of view.

In some embodiments, at least one wavefront replicator is used. In these embodiments, the term “replica” may be used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

In the present disclosure, the term “field of view” refers to the angular extent of the holographic reconstruction that is viewable at a viewing window of a holographic projection system. The field of view is generally determined by the range of angles (e.g. horizontal and vertical angles) over which a viewer can see the full holographic reconstruction of the picture. The field of view is usually limited by the diffraction angle of the display device. However, in accordance with the present disclosure, the field of view may be increased in at least one dimension (e.g., the angular extent of the holographic reconstruction in the horizontal dimension may be increased to provide a “widescreen” aspect ratio).

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2A shows a schematic view of an example pixellated display device of a holographic projection system;

FIG. 2B shows the maximum diffraction angle of the pixellated display device of FIG. 2A;

FIG. 3 shows a schematic cross-sectional view of a portion of an example holographic projection system with angular steering;

FIG. 4A shows an example hologram of a target picture comprising left and right picture areas for projection by a holographic projection system with angular steering;

FIG. 4B shows a cross-sectional view of a holographic wavefront redirector for the holographic projection system arranged to display the hologram of FIG. 4A in accordance with a comparative example;

FIG. 5A shows another example hologram of the target picture comprising left and right picture areas for projection by a holographic projection system with angular steering;

FIG. 5B shows a cross-sectional view of a holographic wavefront redirector for the holographic projection system arranged to display the hologram of FIG. 5A in accordance with a comparative example;

FIG. 6 illustrates the left and right picture areas of the target picture formed by a holographic projection system with angular steering before and after projection through a holographic wavefront redirector according to the comparative examples of FIGS. 4B and 5B;

FIG. 7A and 7B show the formation of unwanted copies of the left and right picture areas formed by a holographic projection system with angular steering comprising a holographic wavefront redirector according to the comparative examples of FIGS. 4B and 5B;

FIG. 8 shows the formation of diffraction orders by a diffraction grating;

FIG. 9 schematically illustrates the formation of diffraction orders of left and right picture areas of the target picture by a holographic wavefront redirector of a holographic projection system with steering according to the comparative examples of FIGS. 4B and 5B;

FIG. 10 schematically illustrates the formation of diffraction orders of the left and right picture areas of the target picture by a holographic wavefront redirector of a holographic projection system with steering according to present disclosure;

FIG. 11 shows an example holographic wavefront redirector in accordance with an embodiment, and

FIG. 12 shows how the target picture is repositioned by a holographic projection system with steering according to the present disclosure.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

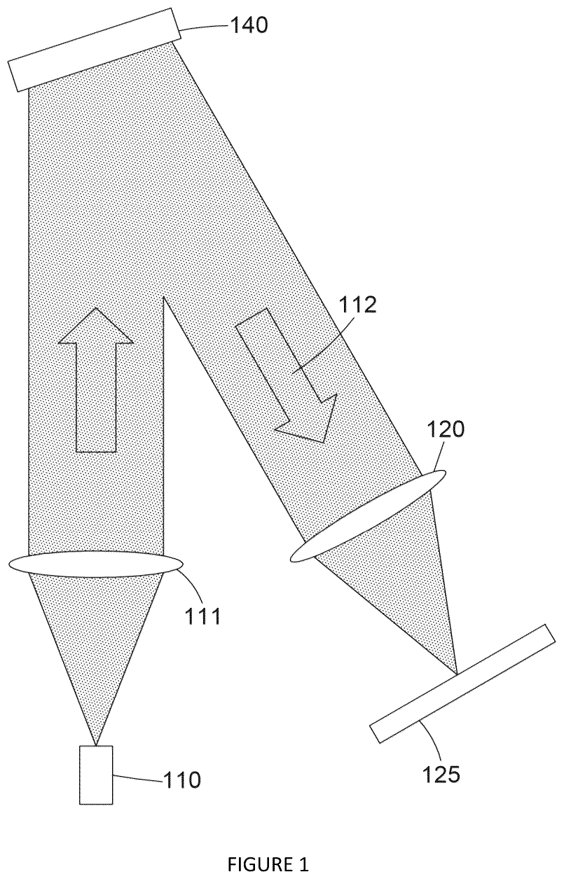

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through a ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two-orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system—as described in British patent 2,603,518 for example which is incorporated herein in its entirety by reference.

### Two-Dimensional Pupil Expansion

Embodiments of the present disclosure may be used with an optical system providing two-dimensional pupil expansion using a pair of orthogonal pupil expanders (or wavefront replicators)—as described in British patent 2,614,286 for example which is incorporated herein in its entirety by reference.

### Combiner Shape Compensation

An advantage of projecting a hologram to the eye-box is that optical compensation can be encoded in the hologram (see, for example, European patent 2,936,252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2,936,252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent 2,607,899, incorporated herein in its entirety by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Holographic Projector with Angular Steering

As described herein, a holographic projection system comprises display device (e.g., spatial light modulator) and, optionally, a pupil replicator or expander. The display device is encoded with a hologram of a picture and is illuminated with light in order to output light that is spatially modulated according to the hologram. The output light comprises a wavefront for forming a holographic reconstruction of the picture. The pupil replicator relays the wavefront to an eye-box. In some embodiments, the pupil replicator comprises first and second pupil replicators, which replicate the wavefront in two dimensions as described above. In some arrangements, the (replicated) wavefront is relayed to an optical combiner, which reflects at least a portion of the wavefront to the eye-box to form a virtual image. A viewing system (e.g., the pupil of a user) is positioned at the eye-box to receive light of the wavefront. A holographic reconstruction is viewable from the eye-box.

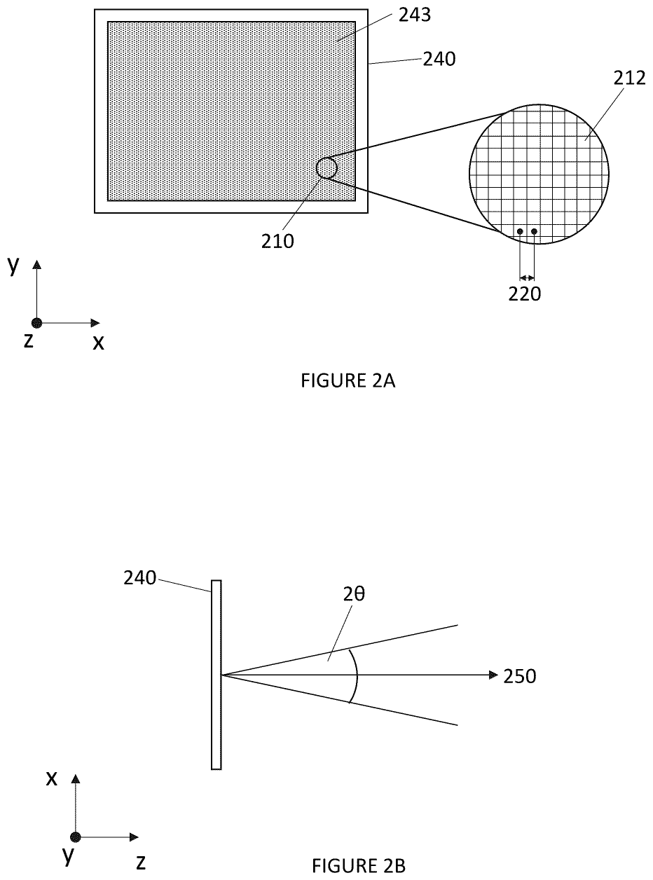

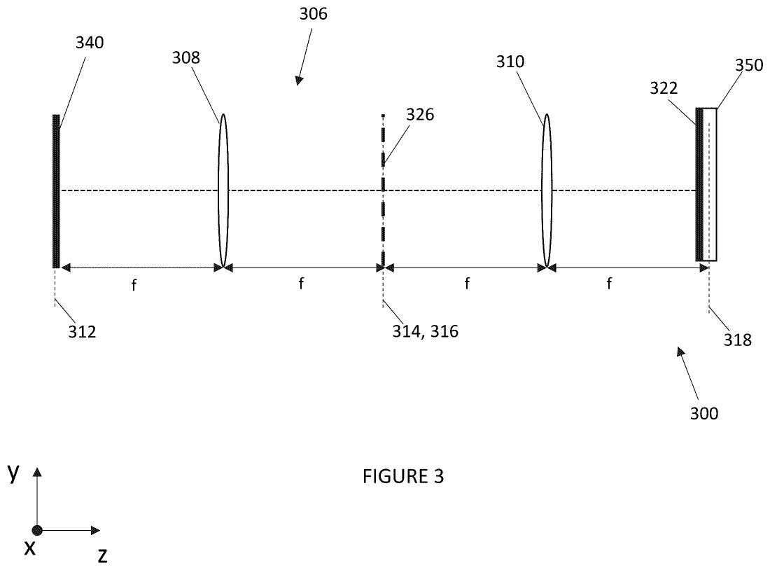

FIG. 2A shows a schematic view of an example display device 240 of a holographic projection system. In this example, the display device 240 is a pixelated liquid crystal on silicon (LCoS) spatial light modulator. The display device 240 comprises a display area 243 containing the pixels of the display device in periodic array of rows and columns. A portion 210 of the display device 240 is magnified to more clearly show how individual pixels 212 of the display device 240 are arranged in an array. In this example, each pixel 212 is square. A pixel pitch 220 of the display device 240 is defined as the distance between the respective centres of adjacent pixels 212 in the array. In this example, since the pixels 212 are square, the pixel pitch 220 is equal in a first (x) direction and second (y) direction that is perpendicular to the first (x) direction.

The (maximum) diffraction angle of the display device 240 is dependent on this pixel pitch, according to the following equation:

$$θ = \pm {sin}^{- 1} ( \frac{λ}{2 x} )$$

where θ is the diffraction angle, λ is the wavelength of incident light and x is the pixel pitch 220.

FIG. 2B represents the maximum range of diffraction angles of the display device. The central arrow 250 represents a projection axis of the holographic projection system. In all examples, the size of the field of view, and this the size of the holographic reconstruction or replay field, of a holographic projection system is dependent on the maximum diffraction angle. For example, the field of view of a holographic projection system may be substantially equal to 2θ.

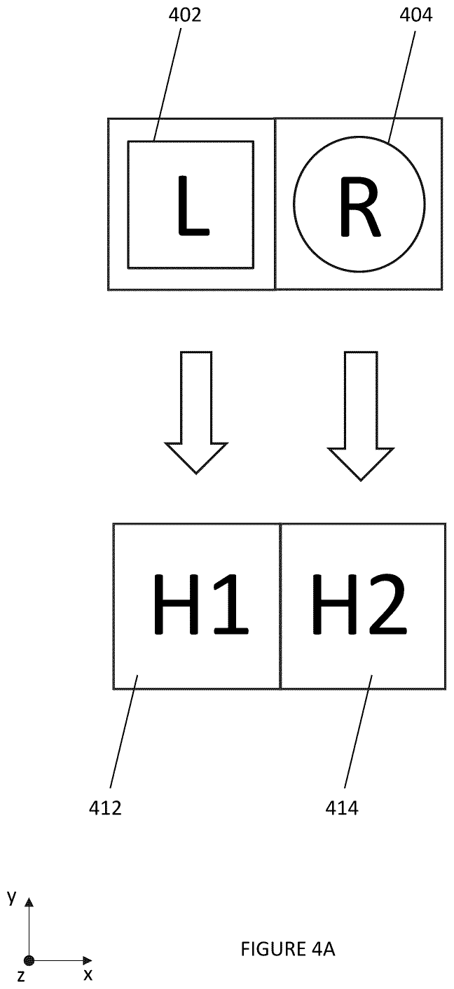

FIG. 3 shows a schematic cross-sectional view of portion of an example holographic projection system 300. The holographic projection system 300 comprises a display device 340 and an optical relay 306 downstream of the display device 340. The optical relay 306 comprises a first lens 308 and a second lens 310 downstream of the first lens 308. In this example, the optical power of the first lens 308 is equal to the optical power of the second lens 310. Furthermore, the focal length of the first and second lenses 308, 310 are the same (and are equal to f, as represented by the arrows in FIG. 3). The first lens 308 comprises a front focal plane 312 and a back focal plane 314. The second lens 310 comprises a front focal plane 316 and a back focal plane 318. The back focal plane 314 of the first lens 308 and the front focal plane 316 of the second lens 310 are co-planar. Thus, the optical relay 306 may be referred to as a “4f” system because the distance between the front focal plane 312 of the first lens 308 and the back focal plane 318 of the second lens 310 is equal to four times the focal length, f, of the first and second lens 308, 310. The display device 340 is substantially coplanar with the front focal plane 312 of the first lens 308. The holographic projection system 300 further comprises a holographic wavefront redirector 350. In the illustrated arrangement, the holographic wavefront redirector 350 is substantially coplanar with the back focal plane 318 of the second lens 310. In other arrangements, the holographic wavefront redirector may be positioned at the plane of the display device 340, and thus substantially coplanar with the back focal plane 312 of the first lens 308.

The display device 340 in this example is an LCOS spatial light modulator. The display device 340 is arranged to display a sequence of holograms of a respective sequence of target pictures. The display device 340 is arranged to be illuminated by coherent light from a light source (such as laser light of a laser). The display device 340 is arranged to spatially modulate the light incident thereon in accordance with a respective hologram of a respective target picture. This forms a holographic wavefront. The holographic projection system 300 is arranged such that the holographic wavefront is relayed/propagated to the optical relay 306 to be received by the first lens 308 and the second lens 310 in turn. The first lens 308 of the optical relay is arranged to form a holographic reconstruction 326. This holographic reconstruction 326 may be formed substantially at the back focal plane 312 of the first lens 308. The second lens 310 is arranged to form a relayed hologram 322 at the back focal plane 318. The relayed hologram 322 corresponds to the display device (comprising the displayed hologram of the target picture). In this example, the holographic wavefront redirector 350 (positioned at the back focal plane 312 or 318) is arranged to act on/process the holographic wavefront.

As the skilled person will appreciate, the term “angular steering”, “beam steering” or simply “steering” or “turning” means changing the propagation direction/axis of light, and thus may be defined in terms of an angular change in the propagation direction/axis of light in one or two dimensions. Accordingly, steering may be defined by an angle of the propagation direction/axis of output light with respect to the propagation direction/axis of incident light in one or two dimensions.

The holographic projection system 300 may further comprise first and second waveguides (not shown) downstream of the holographic wavefront redirector 350. It should be understood that the processed holographic wavefront is relayed from the holographic wavefront redirector 350 to the first and second waveguides where the holographic wavefront is replicated. After replication, the holographic projection system 300 may be arranged such that the replicated holographic wavefront is relayed to an optical combiner. At least a portion of the intensity of the holographic wavefront is reflected/relayed by the optical combiner to an eye-box.

### Hologram Wavefront Redirector

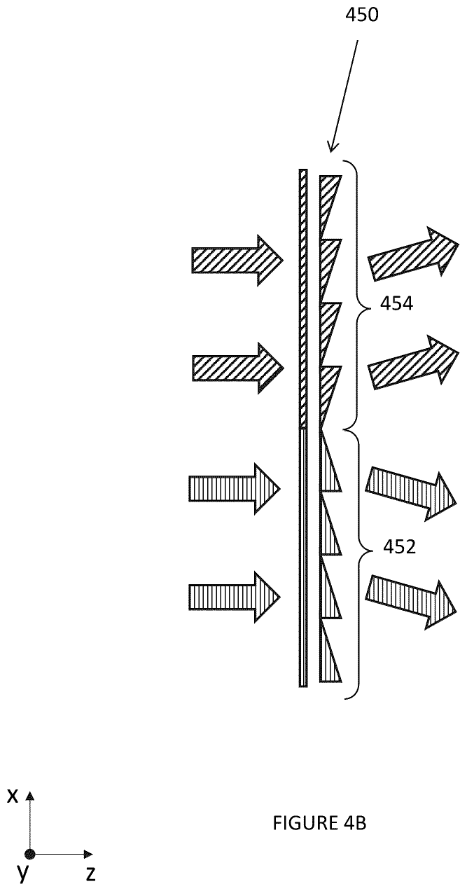

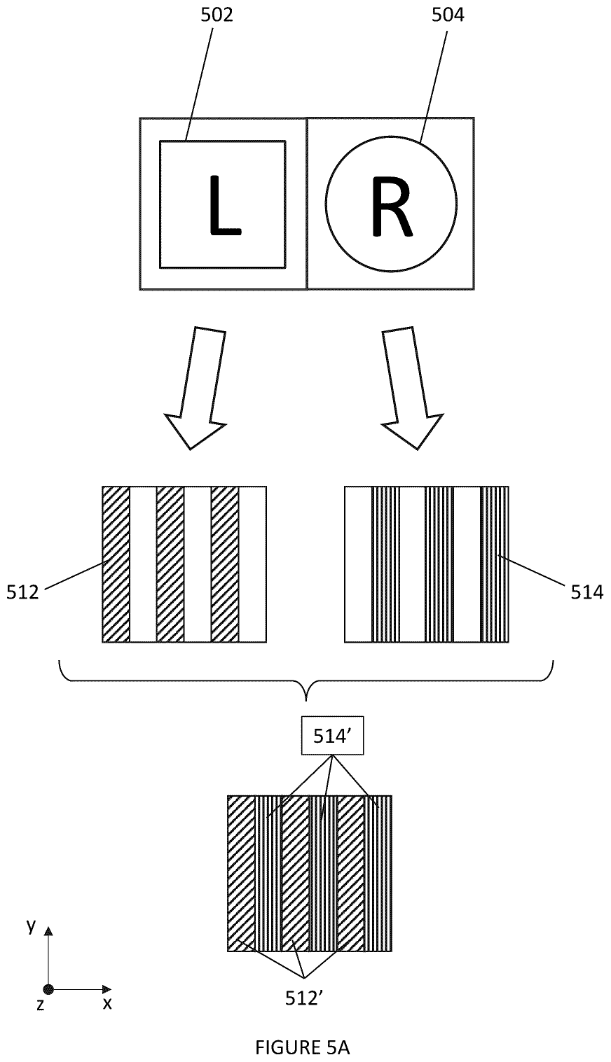

The holographic projection system of FIG. 3 is arranged to reconstruct a target picture comprising two or more picture areas. Each picture area may comprise different picture content to be formed at different spatial positions on the picture plane such as within the picture. In an embodiment represented by top part of FIG. 4A, a target picture is divided into a left picture area comprising left picture content and a right picture area is in right picture content. Thus, the left and right picture areas are arranged side-by-side in the horizontal dimension. In this example, the left picture content is represented by the letter L in a square, and the right picture content is represented by the letter R in a circle. Accordingly, the left and right picture areas are contiguous and non-overlapping in the holographic reconstruction of the target picture. The skilled person will appreciate that, in other examples, the target picture may be formed from multiple picture areas comprising different picture content arranged in any desired spatial positions. Accordingly, the multiple picture areas may be spatially separated and/or overlapping in the first and/or second dimensions of the holographic reconstruction of the target picture.

A number of possible schemes may be used to determine a hologram of a picture comprising two or more picture areas for display by a display device of a holographic projection system. Conventionally, a single hologram of the complete picture may be calculated and displayed on the display device. However, the inventors have proposed calculating a hologram of each of the two or more picture areas to form respective sub-holograms, and spatially interlacing the sub-holograms to form a (combined/composite) hologram of the picture for display. A holographic projection system arranged to display the resulting hologram on a display device may perform angular steering of the portion(s) of the holographic wavefront associated with each sub-hologram in order to position the respective picture areas appropriately within the field of view. This may enable the field of view to be increased above the (maximum) diffraction angle.

FIGS. 4A and 4B illustrate a first example scheme for spatially interleaving a first (sub-) hologram of a first picture area 402 and a second (sub-) hologram of a second picture area 404.

The left and right picture areas 402, 404 are contiguous areas of the target picture, in particular corresponding to the left and right halves of the field of view (holographic reconstruction of the complete target picture), respectively. A hologram of the left picture area 402 is calculated for form a first sub-hologram 412 and a hologram of the right picture area 404 is calculated to form a second sub-hologram 414. A (combined/composite) hologram 410 for display is determined by spatially positioning the first sub-hologram 412 next to the second sub-hologram 414, as shown in FIG. 4A.

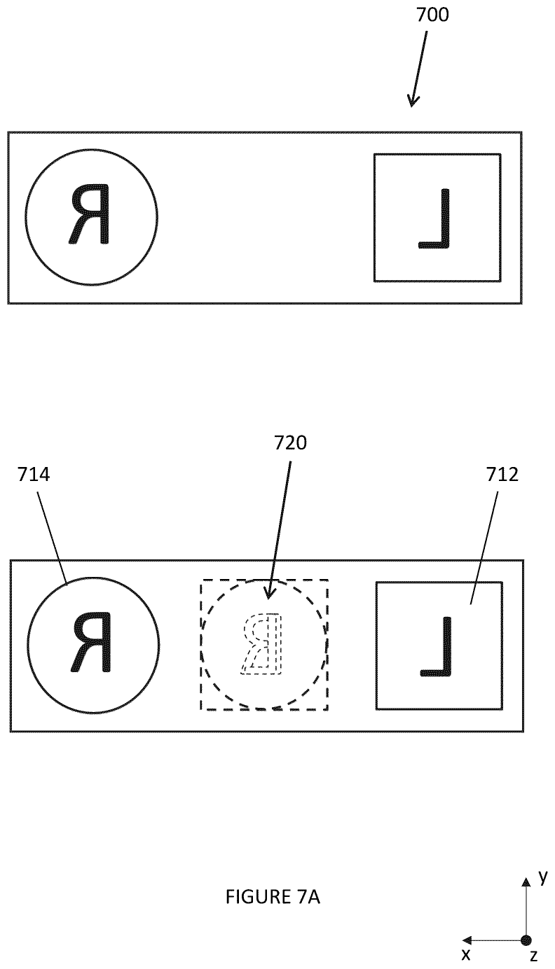

FIG. 4B shows a cross-sectional view of the corresponding holographic wavefront redirector 450 for angularly steering a holographic wavefront formed by illuminating the (combined/composite) hologram of FIG. 4A. Holographic wavefront redirector 450 extends in a plane in first and second dimensions (e.g., x and y dimensions) and the projection axis of the holographic wavefront is in a third dimension (e.g., z dimension) orthogonal to the first and second dimensions. Holographic wavefront redirector 450 comprises a diffraction element comprising a first diffraction zone 452 and a second diffraction zone 454. The first and second diffraction zones 452, 454 comprise different respective areas of a diffraction element. The first diffraction zone 452 is optically coupled to the first sub-hologram 412 and the second diffraction zone 454 is optically coupled to the second sub-hologram. The first diffraction zone 452 is arranged to steer or turn light received from the first sub-hologram 412 by a first angle in a first direction (counter-clockwise on the xz plane) relative to the propagation (z) axis, and the second diffraction zone 454 is arranged to steer light received from the second sub-hologram 414 by a second angle in a second direction (clockwise on the xz plane) relative to the propagation (z) axis. In order to position the first picture area 402 adjacent (contiguous) and side-by-side with the second picture area 404 in the field of view, the first angle is equal to the second angle (in magnitude) and the first direction is opposite to the second direction. In particular, the first and second angles are substantially equal to half the (maximum) diffraction angle (θ/2) of the pixel array of the display device, as shown in FIG. 6, in order to double the size (angle) of the field of view (2θ)—in the x-direction. Thus, the propagation axis of light of each portion of the output holographic wavefront received from the first and second sub-holograms 412, 414, respectively, is “off axis” in the first dimension (x dimension) relative to the propagation axis of the incident holographic wavefront, but is “in plane” in the first and second dimensions (x-y plane).

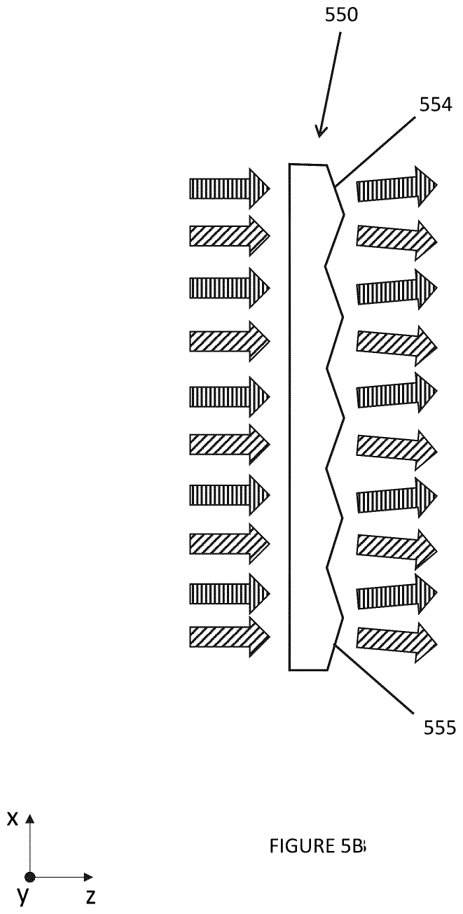

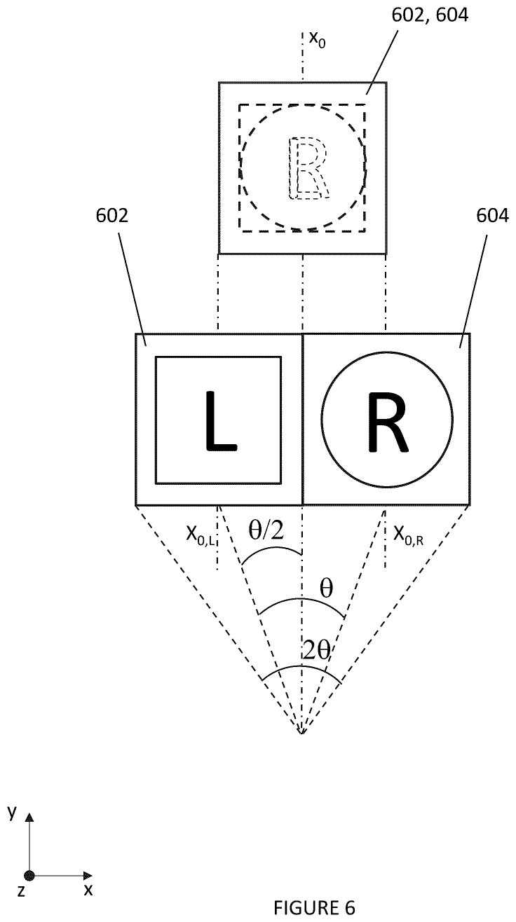

FIG. 5A and 5B illustrate a second example scheme for determining a (combined/composite) hologram of a target picture comprising left and right picture areas for display, and a corresponding holographic wavefront redirector.

As in FIGS. 4A and 4B, the target image comprises a left picture area 502, corresponding to a left half of the field of view, comprising first picture content (the letter L in a square) and a right picture area 404, corresponding to a right half of the field of view, comprising second picture content (the letter R in a circle). A hologram of the left picture area 502 is calculated for form a first sub-hologram 512 and a hologram of the right picture area 504 is calculated to form a second sub-hologram 514. A (combined/composite) hologram for display is determined by spatially interlacing “strips” of hologram pixels of the first and second sub-holograms 512, 514, as shown in FIG. 5A. In particular, the (combined/composite) hologram comprises a plurality of strips of (one or more) columns of hologram pixels of the first sub-hologram 512 interlaced with a plurality of strips of (one or more) columns of hologram pixels of the second sub-hologram 514. Thus, the (combined/composite) hologram comprises first and second sub-hologram strips 512′ 514′ of hologram (sub-) pixels extending in a second direction (vertical or y direction), wherein the first and second sub-hologram strips 512′, 514′ are arranged alternately in a first direction (horizontal or x direction).

FIG. 5B shows a cross-sectional view of a holographic wavefront redirector 550 for angularly steering a holographic wavefront formed by illuminating the (combined/composite) hologram of FIG. 5A. As in the arrangement of FIG. 4B, holographic wavefront redirector 550 extends in a plane in first and second dimensions (e.g., x and y dimensions) and the projection axis of the holographic wavefront is in a third dimension (e.g., z dimension) orthogonal to the first and second dimensions. Holographic wavefront redirector 550 comprises a diffraction element comprising a plurality of first diffraction zones 554 and a plurality of second diffraction zones 555. Each zone of the plurality of first and second diffraction zones 554, 555 comprise a separate area of a diffraction element. Each of the first diffraction zones 554 is optically coupled to a respective strip 512′ of the first sub-hologram 512 and each of the second diffraction zones 555 is optically coupled to a respective strip 514′ of the second sub-hologram 514. Thus, the first and second diffraction zones 554, 555 are elongate in the second direction (y or vertical direction) and arranged alternately in the first direction (x or horizontal direction) to match the respective strips 512′, 514′ of the first and second sub-holograms 512, 514. The first diffraction zones 554 are arranged to steer light received from the first sub-hologram 512 by a first angle in a first direction in the first dimension, and the second diffraction zones 555 are arranged to steer light received from the second sub-hologram 514 by a second angle in a second direction of the first dimension. In order to position the first picture area side-by-side and contiguous with the second picture area in the field of view, the first angle is equal to the second angle and the first direction is opposite to the second direction of the first dimension. In particular, the first and second angles are substantially equal to half the diffraction angle (θ/2), as shown in FIG. 6, in order to double the size (angle) of the field of view (2θ). Thus, the propagation axis of light of each portion of the output holographic wavefront received from the first and second sub-holograms 512, 514, respectively, is “off axis” in the first dimension (x dimension) relative to the propagation axis of the incident holographic wavefront, but is “in plane” in the first and second dimensions (x-y plane).

The top part of FIG. 6 illustrates the left and right picture areas 602, 604 of the example target picture formed by a holographic projection system without angular steering in accordance with this disclosure. The size of the field of view in the first and second directions (x and y dimensions) is determined by the diffraction angle θ. Since a single hologram representing both the first and second picture areas is displayed together on the display device, the first and second picture content/areas overlap within the field of view.

The bottom part of FIG. 6 illustrates the left and right picture areas 602,604 of the example target picture formed by a holographic projection system with angular steering, for example using the schemes described above with reference to FIGS. 4A-B and 5A-B. The first and second picture areas 602, 604 are steered (i.e. translated in one-dimension) by the holographic wavefront redirector so that they are adjacent (i.e., contiguous) and arranged side-by-side in the horizontal dimension (x dimension), and thus form respective left and right sides of the field of view. Thus, as shown by dashed lines, the medial vertical line X₀ of the first picture area 602 is steered through an angle having a magnitude corresponding to half the diffraction angle θ/2 and in a direction to the left (i.e., the negative x dimension) shown at X_{0,L}. The medial vertical line X₀ of the second picture area 604 is steered through an angle having a magnitude corresponding to half the diffraction angle θ/2 in a direction to the right (i.e., the positive x dimension) shown at X_{0,R}. In consequence, the field of view in the first, horizontal dimension is increased to double to the diffraction angle 2θ.

The inventors have found that the above schemes for forming a combined (or composite) hologram from sub-holograms of multiple picture areas of a picture for display, and angular steering portions of the combined/composite hologram, lead to a number of advantages. However, the inventors have found certain drawbacks in the quality of the picture, which adversely affects the viewing experience—if not properly addressed.

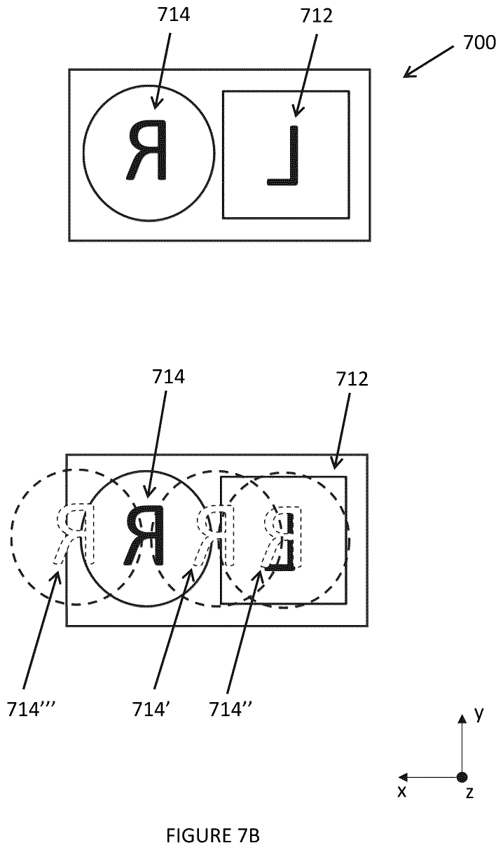

FIGS. 7A and 7B show an example picture 700 (top) and a simulated holographic reconstruction of a hologram thereof formed in a field of view (bottom) by a holographic projection system using the second example scheme as shown in FIGS. 5A and 5B. Thus, as described above, the field of view is increased in the horizontal dimension (x dimension). In particular, the holographic reconstruction comprises a left picture area 712 comprising left picture content (the letter L in a square) on the left side of the field of view (shown on the right side in FIGS. 7A and 7B in the simulations). The left picture area 712 is formed from the portion of the holographic wavefront formed by the left sub-hologram, which is steered by the first plurality of redirection/diffraction zones of the holographic wavefront director to the left side of the holographic reconstruction as described above. In addition, the holographic reconstruction comprises a right picture area 714, adjacent the left picture area 712, comprising right picture content (the letter R in a circle) on the right side of the field of view (shown on the left side in FIG. 7A and 7B in the simulations). Right picture area 714 is formed from the portion of the holographic wavefront formed by the right sub-hologram, which is steered by the second plurality of redirection/diffraction zones of the holographic wavefront director to the right side of the holographic reconstruction as described above.

As shown in FIG. 7A, the left and right picture content of the respective left and right picture areas 712, 714 of the holographic reconstruction is displayed clearly (e.g., good intensity and contrast) compared to the expected picture 700. Also as shown in FIG. 7A, a so-called “DC spot” comprising a high intensity light spot is formed at the centre of each of the left and right picture areas 712, 714 due to unmodulated light.

FIG. 7A illustrates a first issue addressed by the present disclosure. Note that in FIG. 7A, the left and right picture areas of the target picture 700 are arranged to be spatially separated (rather than contiguous) in the horizontal (x) direction, in order to more clearly illustrate this first issue. In particular, the holographic reconstruction in the field of view also comprises a centre area 720 containing a lower intensity copy of the left and right picture areas 712, 714 at the centre of the field of view. In particular, centre area 720 is equidistant between the left and right picture areas 712, 714 in the horizontal dimension (x dimension). In this example, centre area 720 overlaps each of the left and right picture areas 712 714. The centre area 720 comprises duplicate, low intensity copies of the left and right picture content (i.e., the letter L in a square overlaps the letter R in a circle), as well as a duplicate, high intensity “DC spot” familiar to those skilled in the art of holography. The presence of the duplicate copies of the left and right picture content in the central area 720 at the centre of the field of view adversely affects the perceived picture quality.

The inventors have found that the duplicate, overlapping copies of the left and right picture content is formed as a result of a small amount of light of the holographic wavefront formed by the first and second sub-holograms propagating straight through the holographic wavefront redirector, that is without the respective first and second zones of the holographic wavefront redirector changing the propagation direction of the light. The duplicate, overlapping copies of the picture content of multiple picture areas of a target picture at centre of the field of view is therefore referred to herein as the “DC picture”. The inventors realised that the inefficient steering of light, which may lead to the DC picture, may result from imperfections in the diffractive element forming the holographic wavefront redirector, such as gaps between adjacent optical elements of an array of elements forming the periodic, turning elements or “grating lines/slits”.

FIG. 7B illustrates a second issue addressed by the present disclosure. Note that in FIG. 7B, the left and right picture areas of the target picture 700 are arranged side-by-side and contiguous in the horizontal (x) direction. In particular, the holographic reconstruction in the field of view also comprises higher diffraction orders (copies/replicas) of the left and right picture content. The higher diffraction orders are spatially displaced along a line extending in the horizontal dimension (x dimension) and have decreasing intensity. The formation of higher diffraction orders is well known in the art of diffraction and so not described herein. For ease of illustration and understanding, only the higher diffraction orders of the right picture content (comprising the letter R in a circle) are labelled in FIG. 7B. The skilled person will appreciate that one or more higher diffraction orders of the left picture content (comprising the letter L in a square) are also formed in the holographic reconstruction. In particular, the holographic reconstruction comprising the primary diffraction orders of the left and right picture content, in respective in respective left and right picture areas 712, 714. As shown in FIG. 7B, the left and right picture content of the respective left and right picture areas 712, 714 of the holographic reconstruction displays the expected picture 700 in the field of view with good intensity and contrast. However, the holographic reconstruction comprises three (visible) higher diffraction orders of the right picture content (comprising the letter R in the circle) extending horizontally and overlapping the field of view comprising the left and right picture areas 712, 714. In particular, the three higher diffraction orders comprise positive second and third diffraction orders 714′, 714″ and a negative second diffraction order 714″ that form replica copies of the right picture content. These replica copies of the picture content of the higher diffraction orders may be referred to as “ghost” pictures. The presence of the ghost pictures/higher diffraction orders in the field of view adversely affects the perceived picture quality.

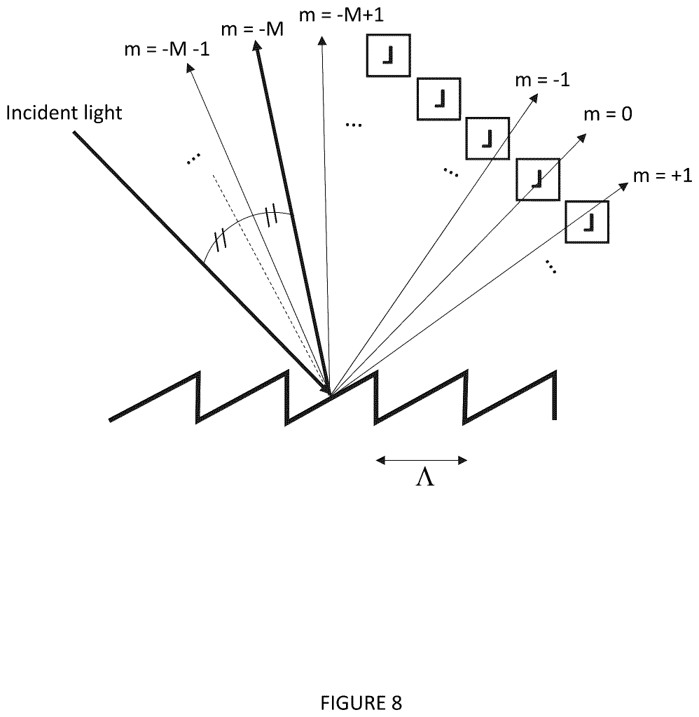

The replica or ghost copies of the left and right picture content formed as higher diffraction orders are formed in embodiments in which the holographic wavefront redirector comprises a periodic structure. For example, the periodic arrangement of the one-dimensional array of elements forming the “grating lines/slits” of the diffraction element of the holographic wavefront redirector may form higher diffraction orders. Accordingly, the higher diffraction orders are formed in a line that extends in the direction of the one-dimensional array of elements forming the “grating lines/slits” of the diffraction element (i.e., a direction perpendicular to the lines/slits) as shown in FIG. 5B. Thus, the higher diffraction orders are formed in a line in the horizontal dimension (x dimension) in the holographic reconstruction. This is because, as shown in FIG. 8, the diffraction orders of a grating structure are formed by light propagating in the same plane. In particular, incident light is steered by the grating to different angles of the same plane (e.g., x-z plane).

Accordingly, the inventors realised that the above problems of undesirable formation of a “DC picture” and “ghost” (higher order) pictures in the field of view, leading to adverse affects on picture quality, are due to the fundamental properties of a diffractive element when used as a holographic wavefront redirector. Embodiments which do not use a diffractive structure as the holographic wavefront redirector may be less affected by these issues but may still benefit from the described diagonal turns. In addition, the inventors realised that these unwanted replicas of the “pictures” are difficult to remove from the holographic wavefront downstream of the holographic wavefront redirector.

### Holographic Wavefront Redirector with Diagonal Steering or Turning

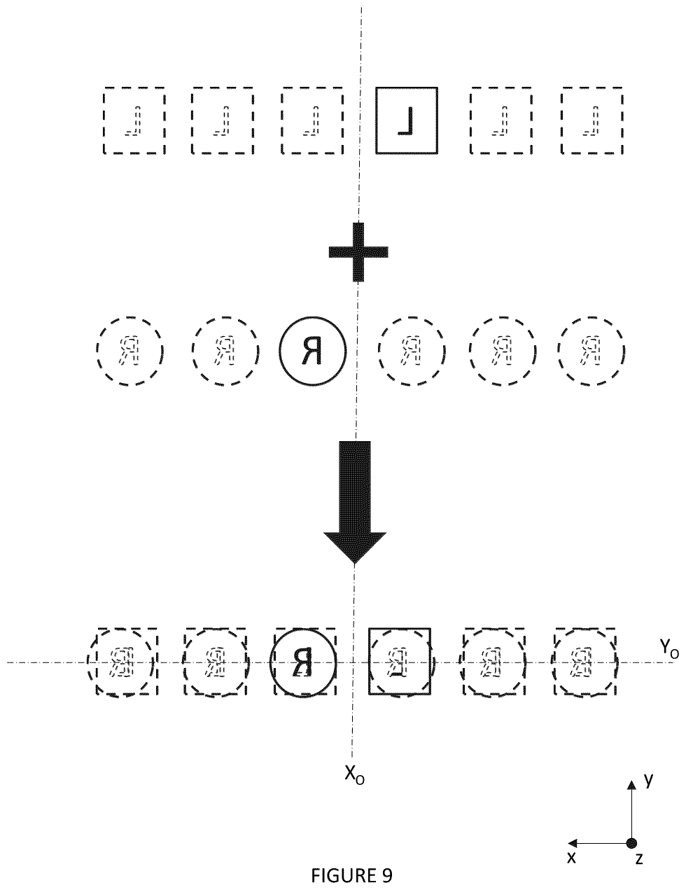

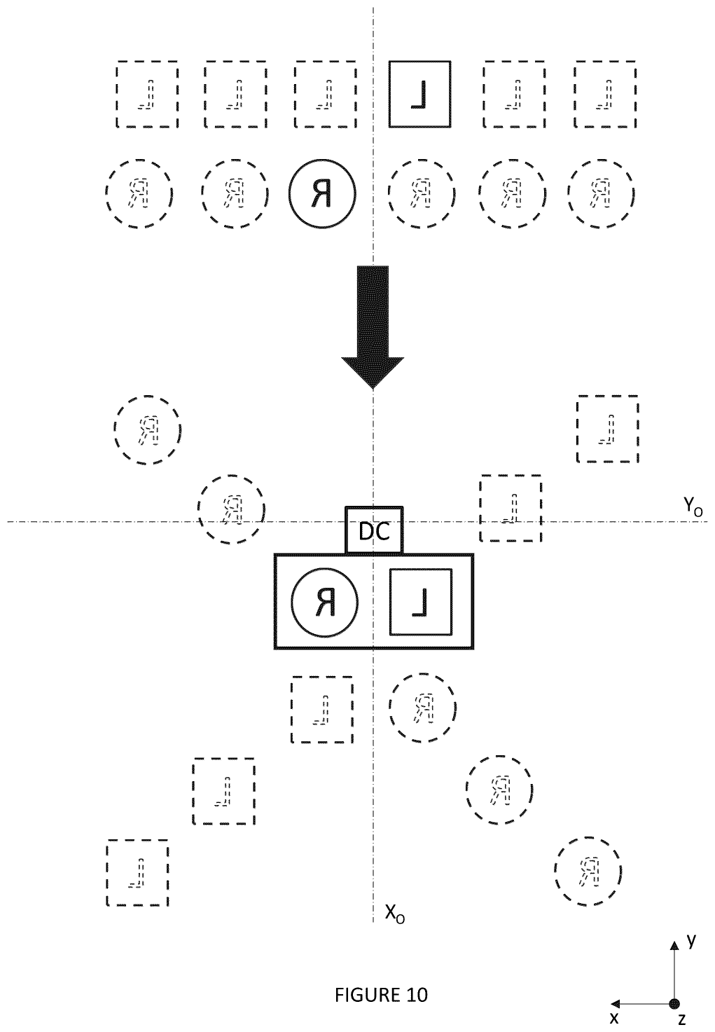

The inventors propose a new approach to address the issues discussed above. In particular, an improved holographic wavefront redirector is proposed that is arranged to steer or “turn” an incident holographic wavefront in a direction “off axis” and “out of the plane”. Thus, instead of only steering the light in the horizontal dimension (x dimension), and thus in a single plane (x-z plane), the light is directed in a diagonal direction. In particular, the diagonal direction has horizontal and vertical components (i.e., extends in both x and y dimensions). Thus, the diagonal direction subtends a first angle relative to the propagation axis (of the incident light) in the horizontal direction and a second angle relative to the propagation axis in the vertical direction. This may be achieved using a 2D diffraction grating structure or a 2D refractive structure. FIGS. 9 and 10 illustrate the effect of the new approach and how it may be used to address the above issues.

FIG. 9 shows an example of one-dimensional (e.g. x-direction) angular steering to form a holographic reconstruction of the example picture comprising a left image area comprising left picture content (comprising the letter L in a square) formed by a first sub-hologram of a (combined/composite) hologram and a right image area comprising right picture content (comprising the letter R in a circle) formed by a second sub-hologram of a (combined/composite) hologram. FIG. 9 shows a first row of diffraction orders of the left picture content (comprising the letter L in a square) and a second row of diffraction orders of the right picture content (comprising the letter R in a circle) formed by the holographic wavefront of the example target image. In addition, FIG. 9 shows a third row comprising the combination of diffraction orders of the left and right picture content as positioned in the holographic reconstruction by the conventional holographic wavefront redirector, for example comprising a diffractive element as shown in FIG. 5B. Each of the first and second rows of diffraction orders extend in the horizontal dimension (x dimension), which is the direction perpendicular to the grating lines/slits of the diffraction element (see FIG. 8).

The first and second diffraction zones of the diffraction element steer respective first and second portions of the holographic wavefront from the first and second sub-holograms by the same angle (e.g., half the diffraction angle) and in opposite directions along the horizontal or x axis. Thus, the primary diffraction order of the left picture content is offset from the medial vertical line X₀ to the left (shown as to the right in FIG. 9) and the primary diffraction order of the right picture content is offset from the medial vertical line X₀ to the right (shown as to the left in FIG. 9). Thus, in the illustrated area of the holographic reconstruction, the first row of diffraction orders of the left picture content (comprising the letter L in a square) comprises positive first and second diffraction orders and negative first, second third diffraction orders, whilst the second row of diffraction orders of the right picture content (comprising the letter R in a circle) comprises positive first, second and third diffraction orders and negative first and second diffraction orders. The skilled person will appreciate that additional higher diffractive orders exist but are not shown in the figures. That is, only a subset of the plurality of higher diffraction orders are illustrated. As shown in the third row in FIG. 9, in the arrangement of the combination of the first and second rows of diffraction orders formed by the conventional holographic wavefront redirector, at least one of the higher diffraction orders of the left picture content and right picture content may overlap the holographic reconstruction/field of view comprising the primary diffraction orders of the left and right picture content (shown at the centre in FIG. 9), as described above with reference to FIG. 7B.

FIG. 10 shows an alternative approach to steering of the example target image in accordance with the present disclosure. In particular, the holographic wavefront redirector is arranged to steer respective portions of the wavefront in a diagonal direction (i.e., in a direction having a horizontal or x component and a vertical or y component). This approach may be called “diagonal steering” or “diagonal turning” and may be implemented, for example, using a diffraction element comprising a 2D diffraction grating structure, or a refractive element comprising a 2D surface or plurality of 2D surfaces. In particular, FIG. 10 shows a first row of diffraction orders of the left picture content (comprising the letter L in a square) and a second row of diffraction orders of the right picture content (comprising the letter R in a circle) formed by the holographic wavefront of the example target image, equivalent to FIG. 9. In addition, FIG. 10 shows a third arrangement comprising the combination of the first and second rows of diffraction orders of the left and right picture content as positioned in the holographic reconstruction by a holographic wavefront redirector comprising a diffraction element in accordance with the present disclosure.

The first and second diffraction zones of the diffraction element are arranged to steer respective portions of the holographic wavefront from the first and second sub-holograms by the same angle (e.g., half the diffraction angle in the illustrated example), in opposite directions, along the horizontal or x axis and by the same angle (e.g., one diffraction angle in the illustrated example), in the same direction, along the vertical or y axis. The skilled person will appreciate that the vertical displacement may be in either direction in the vertical dimension (y axis). Since the respective portions of the holographic wavefront are steered by the same angle, and in opposite directions, along the horizontal or x axis, the primary order of the left picture content (comprising the letter L in a square) is offset from the medial vertical line X₀ to the left (shown as to the right in FIG. 10) and the primary order of the right picture content (comprising the letter R in a circle) is offset from the medial vertical line X₀ to the right (shown as to the left in FIG. 10). In addition, since the respective portions of the wavefront are steered by the same angle, in the same direction, along the vertical or y direction, the primary order of both the left and right picture content is offset from the medial horizontal line Y₀ (shown below the line Y₀ in FIG. 10).

Furthermore, the higher diffraction orders of the left and right picture content are also vertically displaced and so extend in diagonal directions that are equal and opposite in both the horizontal and vertical dimensions. In particular, the diffraction orders of the left picture content are centred on a diagonal line that extends from the bottom left to the top right of the holographic reconstruction shown in FIG. 10 and the diffraction orders of the right picture content are centred on a diagonal line that extends from the bottom right to the top left of the holographic reconstruction shown in FIG. 10.

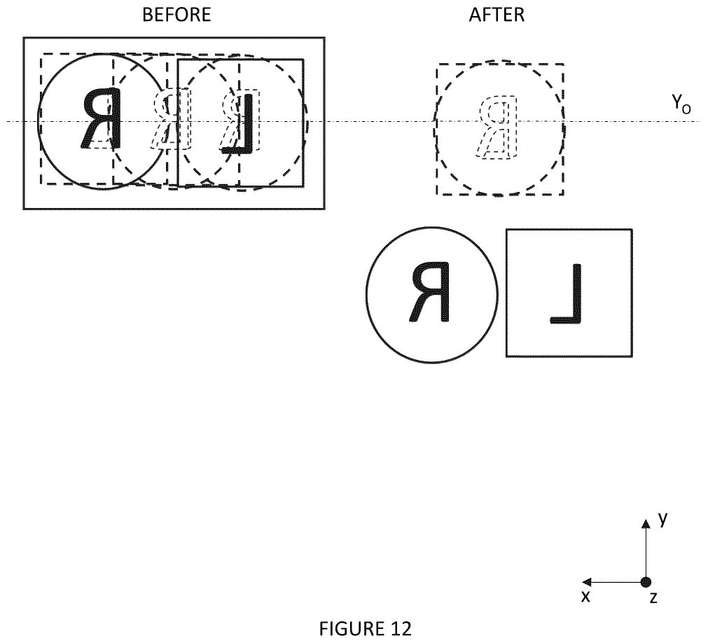

The third arrangement of FIG. 10 also shows the zero-order comprising the DC picture (not to be confused with the DC spot). As discussed above with reference to FIG. 7A, the DC picture corresponds to light of the wavefront that is not steered by the holographic wavefront redirector, and so remains at the centre (intersection of the horizontal and vertical medial lines Y₀, X₀) of the holographic reconstruction. FIG. 12 shows the position of the primary diffraction orders of the left and right picture content and the zero order “DC picture” formed by the holographic reconstruction of FIG. 9 using 1D steering (left) and the holographic reconstruction of FIG. 10 using diagonal steering according to the present disclosure (right). A shown on the left-hand side of FIG. 12, when using 1D steering, the field of view comprises the primary diffraction orders of the first and second picture content and the zero order picture of the holographic reconstruction, which are all formed along the medial horizontal line Y₀. Thus, as described above with reference to FIG. 7A, the DC picture overlaps the primary pictures. However, as shown on the right-hand side of FIG. 12, when using diagonal steering, the primary diffraction orders of the holographic reconstruction are vertically displaced “out-of-plane” (or “off axis” in the vertical dimension), and so vertically offset from (e.g., below) the medial horizontal line X₀. However, the zero-order picture continues to be formed along the medial horizontal line Y₀. Thus, the DC picture is positioned outside the area comprising the primary diffraction orders of the first and second picture content. Optionally, in some embodiments, the sub-holograms of the target image are determined to compensate for the change in the vertical position of the primary diffraction orders of the holographic reconstruction in the vertical direction, which form the field of view.

Accordingly, as shown in the third arrangement of FIG. 10, the approach of diagonal steering has the effect of spatially positioning the primary diffraction orders of the left and right picture content adjacent each other in a side-by-side arrangement, to form a combined (or composite) holographic reconstruction of the example target image as a field of view. At the same time, the approach spatially separates the primary diffraction orders from both the zero order and the higher diffraction orders, thereby preventing overlap. Thus, since the duplicate pictures (i.e., DC picture and ghost pictures), which are formed as a result of the fundamental properties of the diffractive element as discussed above with reference to FIGS. 7A and 7B, are positioned outside the area containing the primary diffraction orders, there is no adverse effect on the perceived picture quality for the viewer.

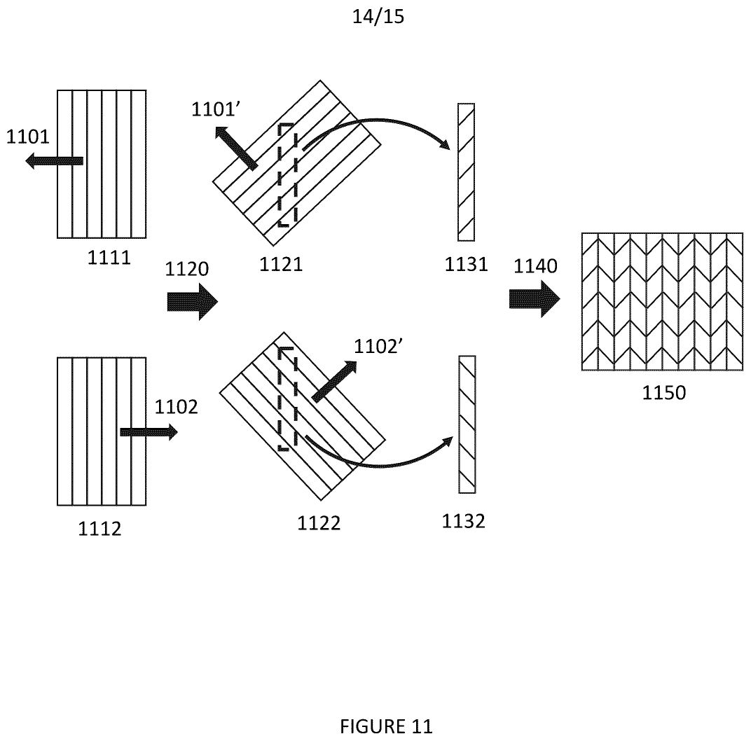

FIG. 11 helps understand the structure of the two zones of an example holographic wavefront redirector in accordance with this disclosure. FIG. 11 shows a first 1D redirection structure 1111 comprising a first repeating (or wrapped) phase ramp as can be understood from the foregoing. FIG. 11 also shows a second 1D redirection structure 1112 having a second steering direction 1102. The first 1D redirection structure 1111 has a first steering direction 1101 and the second 1D redirection structure 1112 has a second steering direction 1102 which is opposite (in direction) to the first 1D steering direction 1101. Each of the first redirection structure 1111 and second redirection structure has a cross-section corresponding to the repeating (or wrapped) phase ramp of FIG. 8—except they “ramp” in opposite directions. Each structure may be a bulk optic or a phase-delay pattern displayed on a display device. Alternatively, each structure may be a diffractive structure. Conceptually, this embodiment may be understood by rotating (step 1120 of FIG. 11) each structure by 45 degrees to form a first rotated structure 1121 having a first rotated steering direction 1101′ and a second rotated structure 1122 having a second rotated steering direction 1102′. A slice or strip of each structure may be used to form a first unit cell 1131 and a second unit cell 1132 which are alternated and interleaved (step 1140 of FIG. 11) to form the holographic wavefront redirector 1150 of this embodiment. As will be understood a first plurality of zones interact with a first potion of the holographic wavefront and a second plurality of zones interact with a second portion of the holographic wavefront. The first and second zones are interleaved and steer (or turn the holographic wavefront) in opposing directions.

FIG. 12 is a drawing which represents an experimental result achieved in accordance with the present disclosure to verify the concept.

It will be apparent to those skilled in the art that various modifications and variations can be made without departing from the scope of the appended claims. The present disclosure covers all modifications and variations within the scope of the appended claims and their equivalents.

What is claimed is:

1. A holographic projection system arranged to display a picture, wherein the holographic projection system comprises:
a hologram of a picture, wherein the hologram comprises a first sub-hologram corresponding to a first picture area of the picture and a second sub-hologram corresponding to a second picture area of the picture;
a holographic wavefront redirector positioned substantially adjacent to one of the hologram or a relayed copy of the hologram, wherein the holographic wavefront redirector comprises (i) one or more first redirection zones optically coupled to the first sub-hologram and (ii) one or more second redirection zones optically coupled to the second sub-hologram; and
wherein each of the one or more first redirection zones is arranged to turn received light by a first diagonal turn with respect to a propagation axis of the holographic projection system and each of the one or more second redirection zones is arranged to turn received light by a second diagonal turn with respect to the propagation axis, wherein the second diagonal turn is different than the first diagonal turn.

2. The holographic projection system of claim 1, wherein the first diagonal turn and second diagonal turn each comprise a first angular component and second angular component with respect to the propagation axis.

3. The holographic projection system of claim 2, wherein the first angular component of the first diagonal turn is equal and opposite to the first angular component of the second diagonal turn.

4. The holographic projection system of claim 3, wherein the first angular component of the first diagonal turn and second diagonal turn are equal to half of a diffraction angle of the hologram.

5. The holographic projection system of claim 2, wherein the second angular component of the first diagonal turn is equal to the second angular component of the second diagonal turn.

6. The holographic projection system of claim 2, wherein the second angular component of the first diagonal turn and the second angular component of the second diagonal turn are at least equal to a diffraction angle of the hologram.

7. The holographic projection system of claim 1, wherein each redirection zone is formed from a transparent material comprising a first surface arranged to receive light modulated in accordance with a respective part of the hologram, and a second surface arranged to refract the light modulated in accordance with the respective part of the hologram in order to provide the corresponding diagonal turn.

8. The holographic projection system of claim 7, wherein the first surface of each of the one or more first redirection zones is substantially parallel to a plane of the hologram and the second surface of each of the one or more first redirection zones is tilted by a first tilt angle with respect to the plane of the hologram such that an angle of incidence of received light on the second surface is greater than zero, and the first surface of each of the one or more second redirection zones is substantially parallel to the plane of the hologram and the second surface of each of the one or more second redirection zones is tilted by a second tilt angle with respect to the plane of the hologram such that an angle of incidence of received light on the second surface is greater than zero, wherein the first tilt angle is equal and opposite to the second tilt angle.

9. The holographic projection system of claim 8, wherein each second surface is a Fresnel-type structure comprising a plurality of second surface components.

10. The holographic projection system of claim 1, wherein the holographic wavefront redirector is a phase-delay function displayed on a spatial light modulator.

11. The holographic projection system of claim 10, wherein each redirection zone comprises at least one phase-ramp function arranged to provide the corresponding turn, wherein each phase-ramp function is linear and two-dimensional.

12. The holographic projection system of claim 10, wherein the holographic wavefront redirector comprises a diffractive structure.

13. The holographic projection system of claim 12, wherein the diffractive structure corresponds to a periodicity of the one or more first redirection and the one or more second redirection zones.

14. The holographic projection system of claim 12, wherein the diffractive structure comprises a Fresnel-type structure having a periodic arrangement of surface components.

15. The holographic projection system of claim 12, wherein the diffractive structure corresponds to a periodic arrangement of pixels of a spatial light modulator arranged to display a phase-delay pattern.

16. A method for holographic projection of a picture comprising first and second picture areas arranged side-by-side in a first dimension, wherein the method comprises:
displaying a hologram of the picture, the hologram comprising a first sub-hologram corresponding to the first picture area and a second sub-hologram corresponding to a second picture area;
illuminating the hologram with light to form a holographic wavefront, wherein the holographic wavefront extends in the first dimension and a second dimension perpendicular to the first dimension and propagates in a third dimension perpendicular to the first and second dimensions;
turning light of a first portion of the holographic wavefront by a first diagonal turn with respect to a propagation axis, wherein the first portion of the holographic wavefront is formed by the first sub-hologram, and
turning light of a second portion of the holographic wavefront by a second diagonal turn with respect to the propagation axis, wherein the second portion of the holographic wavefront is formed by the second sub-hologram and wherein the second diagonal turn is different to the first diagonal turn.

17. The method of claim 16, further comprising:
receiving the turned light of the first and second portions of the holographic wavefront and forming a holographic reconstruction corresponding to the picture at a replay plane, wherein a primary diffraction order of each of the first and second sub-holograms forms a field of view, and wherein the zero order and/or the higher diffraction orders of the first and second sub-holograms are spatially separated from the field of view comprising the primary diffraction orders of the first and second sub-holograms at the replay plane.
